(19) United States
(12) Patent Application Publication
(10) Pub. No.: US 2003/0114121 A1
(43) Pub. Date: Jun. 19, 2003

(54) Transmitter circuit for mobile telephone set compatible with two different systems

(75) Inventor: Jiro Kikuchi, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/316,579

(22) Filed: Dec. 11, 2002

(30) Foreign Application Priority Data
Dec. 19, 2001 (JP) 2001-385698
Jul. 9, 2002 (JP) 2002-199381

(51) Int. Cl. H04B 1/02; H04B 7/00; H04Q 7/20

(52) U.S. Cl. 455/91; 455/522

(57) ABSTRACT

A transmitter circuit is configured of a first power amplifier of a variable gain type for amplifying first transmit signals, a second power amplifier of a fixed gain type for amplifying second transmit signals and a preamplifier into which the first or second transmit signals are entered, for supplying the first transmit signals to the first power amplifier and the second transmit signals to the second power amplifier, wherein the preamplifier is changed over so that its gain is fixed when the first transmit signals are to be amplified or is variable when the second transmit signals are to be amplified, and the gain of the first power amplifier and the gain of the preamplifier are controlled with a transmit power setting signal for setting amplitudes of transmit signals supplied by the first and second power amplifiers.

### FIELD OF THE INVENTION

The present invention relates to a transmitter circuit for use in cellular telephone sets, car telephone sets and the like, which are mobile telephone sets, and more particularly to a transmitter circuit for dual mode mobile telephone sets which in transmission, switches the communication system to a pair of different systems including the CDMA system and another system such as AMPS and GSM.

### DESCRIPTION OF THE PRIOR ART

In the field of mobile radio communication, many different communication systems are coexistent, differing in frequency band and modulation system. For instance in the U.S., there are the Code Division Multiple Access (CDMA) system and the Advanced Mobile Phone Service (AMPS) system, and in Europe there are the CDMA system, the Global System for Mobile communication (GSM) system and so forth.

For this reason, so-called dual mode mobile telephone sets have been developed, each of which is compatible with two different communication systems by itself.

Such a telephone set compatible with two communication systems, for instance, a dual mode mobile telephone set used in the U.S., has transmitter circuits for two different systems including one for the AMPS system and the other for the CDMA system, and uses one or the other switched as required.

The transmitter circuit for the AMPS system, as shown in FIG. 3, includes an FM modulator 21, a driver 22, a nonlinear power amplifier 23, a transmit power detector 24 and a gain controller 25.

The FM modulator 21, into which are entered modulating signals and oscillation signals of an oscillation frequency controlled by a PLL circuit (not shown), supplies modulated transmit signals.

The driver 22 preamplifies the transmit signals from the FM modulator 21 with a prescribed gain.

The nonlinear power amplifier 23 subjects the entered transmit signals to nonlinear Class C amplification, and supplies the amplified signals to an antenna (not shown). This nonlinear power amplifier 23 is used for reducing power consumption.

The transmit power detector 24 detects the magnitude of the transmit signals supplied from the nonlinear power amplifier 23, and supplies a signal matching their magnitude.

The gain controller 25, into which are entered signals detected from the transmit power detector 24 and a transmit power setting signal for setting the power level to be supplied by the nonlinear power amplifier 23, supplies a control signal matching the difference between them to the nonlinear power amplifier 23, and causes the nonlinear power amplifier 23 to supply transmit power set by the transmit power setting signal by controlling the gain of the nonlinear power amplifier 23.

In the transmitter circuit for the AMPS system of this configuration, modulating signals and a channel setting signal are entered into the FM modulator 21, and the modulating signals are modulated and supplied to the driver 22.

The modulated signals, after being preamplified by the driver 22, are supplied to the nonlinear power amplifier 23 and, after being amplified by the nonlinear power amplifier 23 to an appropriate amplitude, transmitted from an antenna (not shown) to a base station.

On the other hand, the transmitter circuit for the CDMA system, as shown in FIG. 4, includes a voltage-controlled oscillator 31, a QPSK modulator 32, a variable gain amplifier 33 and a linear power amplifier 34.

The voltage-controlled oscillator 31, whose oscillation frequency is controlled by a PLL circuit (not shown), supplies oscillation signals.

The QPSK modulator 32, into which transmit data (modulating signals) and the oscillation signals supplied by the voltage-controlled oscillator 31 are entered, and these modulating signals and oscillation signals become QPSK-modulated transmit signals, which are supplied to the next stage.

The variable gain amplifier 33, into which the transmit signals modulated by the QPSK modulator 32 and the transmit power setting signal to set the output power are entered, amplifies these transmit signals to an appropriate amplitude, and supplied to the linear power amplifier 34.

The linear power amplifier 34 subjects the input transmit signals to linear Class A amplification, and supplies the amplified signals to an antenna (not shown).

In the transmitter circuit for the CDMA system of this configuration, the oscillation signals supplied by the voltage-controlled oscillator 31 and transmit data (modulating signals) are modulated by the QPSK modulator 32, and the modulated transmit signals are amplified to an appropriate amplitude in two steps by the variable gain amplifier 33 and the linear power amplifier 34, to be transmitted from an antenna (not shown) to a base station.

However, such a configuration provided with separate transmitter circuits of two different systems entails a problem that cost saving is inhibited because each transmitter circuit requires its constituent parts, resulting in an increased number of parts.

Moreover, such a structure requires space for accommodating the two transmitter circuits, resulting in another problem of making it difficult to provide a more compact mobile telephone set.

### SUMMARY OF THE INVENTION

An object of the present invention, attempted in view of the problems noted above is to provide a transmitter circuit for dual mode mobile telephone sets, which is simple in configuration, permits reduction in size, involves a smaller number of parts and costs less.

In order to solve the problems noted above, a transmitter circuit according to the invention is provided with a first power amplifier of a variable gain type for amplifying first transmit signals, a second power amplifier of a fixed gain type for amplifying second transmit signals; and a preamplifier into which the first or second transmit signals are entered, for supplying the first transmit signals to the first power amplifier and supplying the second transmit signals to the second power amplifier, wherein changing-over is accomplished so that, a gain is fixed when the preamplifier is to amplify the first transmit signals and a gain is variable when it is to amplify the second transmit signals, and the gain of the first power amplifier and the gain of the preamplifier are controlled with a transmit power setting signal for setting amplitudes of transmit signals supplied by the first and second power amplifiers.

This configuration makes it possible for the two communication systems to share a single driver, resulting in a reduced number of components and a lower cost.

When the supply of the first transmit signals from the first power amplifier is to be suspended, both the first power amplifier and the preamplifier may be placed in a cut-off state.

This configuration almost completely prevents the first power amplifier from supplying transmit signals, making it possible to satisfy the system specification of −60 dBm or less.

The first power amplifier may be configured of a Class C nonlinear high output amplifier and the second power amplifier of a Class A linear amplifier.

This configuration makes it possible, when the first transmit signals are to be transmitted, power consumption at the time of high power transmission can be reduce and, when the second transmit signals are to be transmitted, high performance transmission free of distortion can be accomplished.

The transmitter circuit may be further provided with a transmit power detector for detecting the amplitude of the transmit signals supplied from the first power amplifier and a gain controller for controlling the gain of the first power amplifier with a signal detected by the transmit power detector and the transmit power setting signal.

This configuration would make possible accurate setting of the amplitude of the transmit signals supplied by the first power amplifier.

In the transmitter circuit, the first transmit signals may be of the AMPS system or the GSM system and the second transmit signals are of the CDMA system.

This configuration would make the transmitter compatible with two different communication systems in the U.S. and Europe.

### BRIEF DESCRIPTION OF THE DRAWINGS

FIG. 1 is a circuit diagram illustrating the configuration of a transmitter circuit according to the present invention;

FIG. 2 is a circuit diagram illustrating the configuration of operation switching for each amplifier in the transmitter circuit according to the invention;

FIG. 3 is a circuit diagram illustrating the configuration of the AMPS system or the GSM system of a transmitter circuit according to the prior art; and

FIG. 4 is a circuit diagram illustrating the configuration of the CDMA system of a transmitter circuit according to the prior art.

### DESCRIPTION OF THE PREFERRED EMBODIMENT

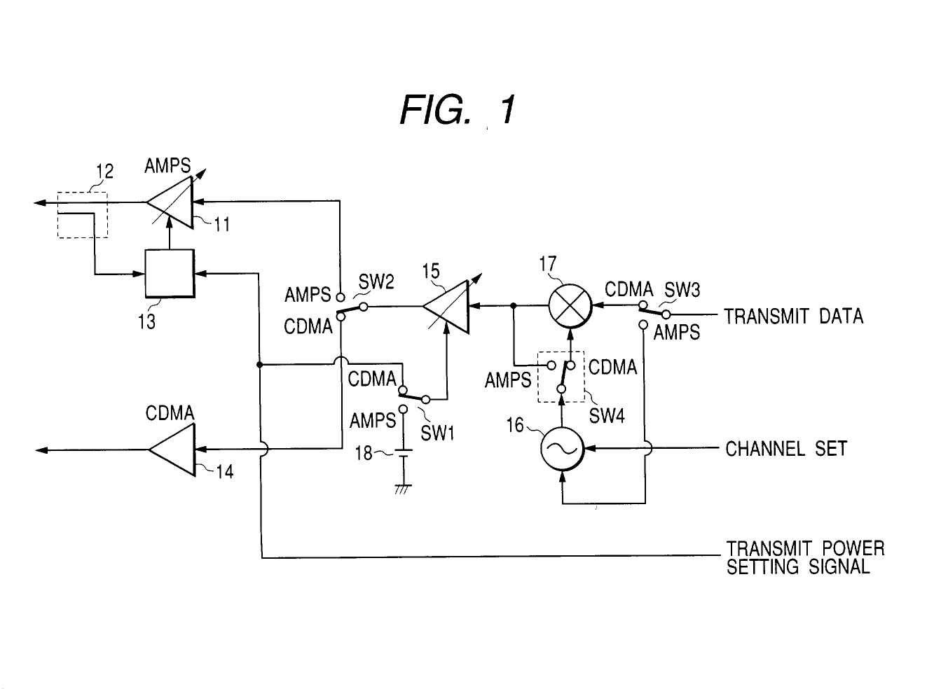

As described below, a transmitter circuit according to the invention is configured of a first power amplifier 11 including a nonlinear power amplifier, a transmit power detector 12 for detecting the power of first transmit signals supplied by the first power amplifier 11, a gain controller 13 for controlling the gain of the first power amplifier 11, a second power amplifier 14 including a linear power amplifier, a preamplifier 15 including a variable gain amplifier, a voltage-controlled oscillator 16, a modulator 17, a bias voltage source 18 for supplying a bias voltage to the preamplifier 15, and four change-over switches SW1, SW2, SW3 and SW4 as shown in FIG. 1. The change-over switches SW1 through SW4 are interlocked with each other.

The first power amplifier 11 subjects the entered first transmit signals of the AMPS system to Class C amplification (a nonlinear action), and the amplified first transmit signals are supplied to an antenna (not shown). As the first power amplifier 11 operates in a Class C mode, it can contribute to power saving.

The transmit power detector 12 detects the power of the first transmit signals supplied by the first power amplifier 11, and supplies a signal corresponding to the detected power to the gain controller 13.

The gain controller 13, into which the signal supplied by the transmit power detector 12 and a transmit power setting signal for setting the power level of the transmit signals to be supplied by this transmitter circuit are entered, supplies a control voltage corresponding to the difference between them to the first power amplifier 11. The gain of the first power amplifier 11 is thereby controlled.

The second power amplifier 14, having a prescribed gain, subjects the entered second transmit signals of the CDMA system to Class A amplification (a linear action), and the amplified second transmit signals are supplied to the antenna (not shown).

The preamplifier 15 amplifies the entered transmit signals of both systems according to a bias voltage or transmit power setting signal that is supplied, and supplies them to the first power amplifier 11 or the second power amplifier 14 via the change-over switch SW2.

The voltage-controlled oscillator 16 supplies the oscillation signals of the oscillation frequency controlled by the PLL circuit (not shown).

The modulator 17 subjects the oscillation signals supplied by the voltage-controlled oscillator 16 to QPSK modulation with the entered transmit data (modulating signals).

The bias voltage source 18 supplies a prescribed fixed bias voltage to bring the gain of the preamplifier 15 to a prescribed level.

The change-over switch SW1 changes over the voltage from the bias voltage source 18 or the transmit power setting signal, and supplies the changed-over voltage or signal to the preamplifier 15, supplying from the bias voltage source 18 when working on the AMPS system or supplying the transmit power setting signal when working on the CDMA system.

The change-over switch SW2 performs a change-over so as to supply the transmit signals from the preamplifier 15 to the first power amplifier 11 when working on the AMPS system or to the second power amplifier 14 when working on the CDMA system.

The change-over switch SW3 performs a change-over so as to enter transmit data (modulating signals) into the voltage-controlled oscillator 16 when working on the AMPS system or into the modulator 17 when working on the CDMA system.

The change-over switches SW4 performs a change-over so as to supply the signal from the voltage-controlled oscillator 16 to the preamplifier 15 when working on the AMPS system or to the modulator 17 when working on the CDMA system.

In the configuration described above, when this transmitter circuit is to transmit first transmit signals of the AMPS system, the movable contacts of the change-over switches SW1 through SW4 are changed over to the “AMPS” side in the diagram.

Then, transmit data (modulating signals) is entered into the voltage-controlled oscillator 16 via the change-over switches SW3. Into this voltage-controlled oscillator 16 is entered a signal to set the channel, and the transmit data is supplied in a modulated state. In this process, the voltage-controlled oscillator 16 operates as a modulator.

The transmit signals supplied by the voltage-controlled oscillator 16 are then entered into the preamplifier 15 via the change-over switch SW4.

The preamplifier 15 performs amplification by a prescribed gain as a bias voltage is supplied from the bias voltage source 18 via the change-over switch SW1.

Next, the transmit signals amplified by this preamplifier 15 are entered into the first power amplifier 11 via the change-over switch SW2 and, being amplified to an appropriate amplitude by the actions of the transmit power detector 12 and the gain controller 13, supplied to the antenna (not shown).

When this transmitter circuit is to transmit signals of the CDMA system, the movable contacts of the change-over switches SW1 through SW4 are changed over to the “CDMA” side in the diagram.

Then, a signal to set the channel is entered into the voltage-controlled oscillator 16, which supplies oscillation signals of a prescribed frequency. These oscillation signals are entered into the modulator 17 via the change-over switch SW4. Transmit data (modulating signals) is also entered into this modulator 17 via the change-over switch SW3, and supplied to the preamplifier 15 in a modulated state.

To this preamplifier 15 is supplied the transmit power setting signal via the change-over switch SW1, and the entered second transmit signals are amplified to an appropriate amplitude and supplied.

The second transmit signals amplified by the preamplifier 15 are entered into the second power amplifier 14 via the change-over switch SW2, amplified to a prescribed gain, and transmitted from the antenna (not shown) to the base station.

The configuration and operations described so far enables this transmitter circuit to perform transmission in two different modes including the AMPS system and the CDMA system.

Since the preamplifier 15 can be commonly used whether working on the AMPS system or on the CDMA system as is evident from FIG. 1, the configuration is simplified. The oscillator can also be commonly used, and accordingly the number of parts is reduced.

To add, although a mode of implementing the invention has been described with reference to the AMPS system, the same configuration can be compatible with the GSM system as well.

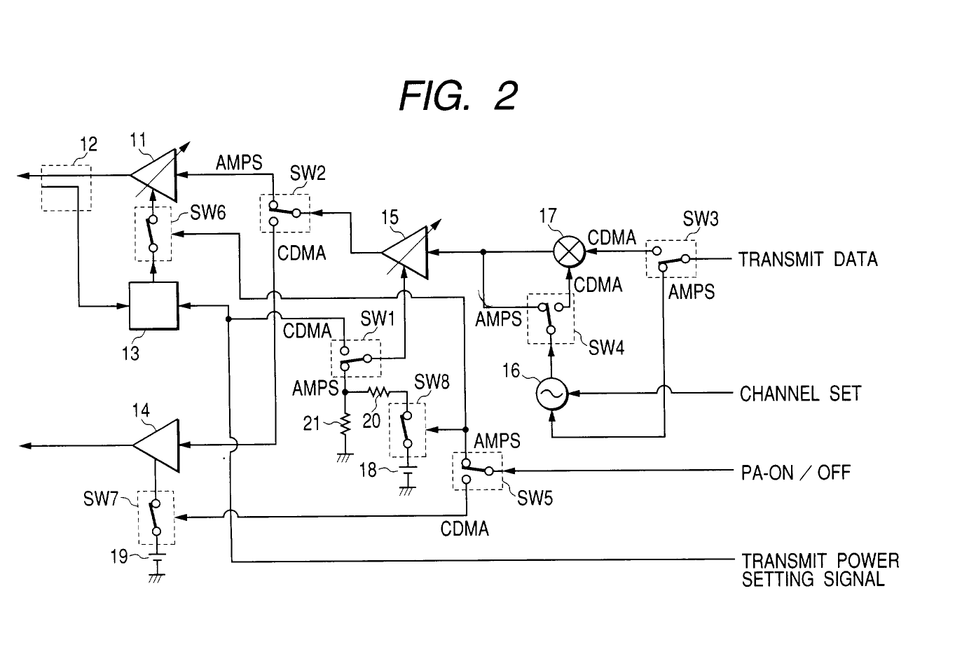

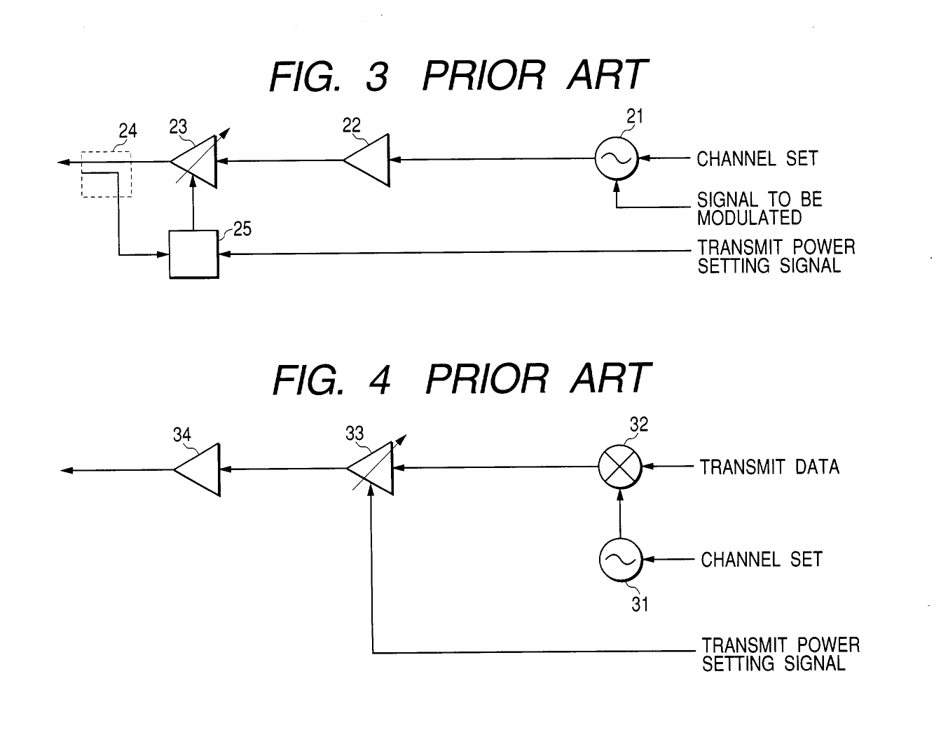

FIG. 2 illustrates the configuration in a manner facilitating more detailed description of the changing-over of operations among the first power amplifier 11, the second power amplifier 14 and the preamplifier 15. An on/off switch SW6 is provided between the first power amplifier 11 and the gain controller 13, and a bias voltage is fed to the second power amplifier 14 from a bias voltage source 19 via an on/off switch SW7. Further, an on/off switch SW8 is provided on the AMPS side contact of the change-over switch SW1, and the voltage from the bias voltage source 18 is supplied to the AMPS side contact via the on/off switch SW8. This voltage is divided by resistors 20 and 21.

Further, power on/off (PA-ON/OFF) signals to place the first power amplifier 11 and the second power amplifier 14 in an operating state during transmission and in a non-operating during reception are supplied to the on/off switch SW6, SW7 and SW8 via a change-over switch SW5.

In the configuration of FIG. 2 described so far, the PA-ON/OFF signals are entered into the on/off switches SW6 and SW8 via the change-over switch SW5 during transmission by the AMPS system to keep these switches on, and a control voltage for controlling the gain is supplied from the gain controller 13 to the first power amplifier 11. At the same time, the voltage from the bias voltage source 18 is supplied to the preamplifier 15 via the change-over switch SW1. During reception on the other hand, the on/off switch SW6 and SW8 are kept off, and both the first power amplifier 11 and the preamplifier 15 are in a cut-off state. Therefore, even if a signal is entered into the preamplifier 15, the level of signals supplied from the first power amplifier 11 is restrained to the standard of −60 dBm or below.

During transmission by the CDMA system on the other hand, the on/off switch SW7 is kept on, and a bias voltage for the second power amplifier 14 is supplied from the bias voltage source 19. During reception, as the on/off switch SW7 is off, no bias voltage is supplied.

As hitherto described, the transmitter circuit according to the present invention is provided with a first power amplifier of a variable gain type for amplifying first transmit signals; a second power amplifier of a fixed gain type for amplifying second transmit signals; and a preamplifier into which the first or second transmit signals are entered, for supplying the first transmit signals to the first power amplifier and supplying the second transmit signals to the second power amplifier, wherein changing-over is so accomplished that, a gain is fixed when the preamplifier is to amplify the first transmit signals and a gain is variable when it is to amplify the second transmit signals, and the gain of the first power amplifier and the gain of the preamplifier are controlled with a transmit power setting signal for setting the amplitudes of transmit signals supplied by the first and second power amplifiers. Accordingly, one driver can be shared for use by the two communication systems, resulting in a reduced number of constituents parts and a lower cost.

What is claimed is:

1. A transmitter circuit provided with a first power amplifier of a variable gain type for amplifying first transmit signals; a second power amplifier of a fixed gain type for amplifying second transmit signals; and a preamplifier into which the first transmit signals or second transmit signals are entered, for supplying the first transmit signals to the first power amplifier and supplying the second transmit signals to the second power amplifier, wherein changing-over is accomplished so that a gain is fixed when the preamplifier is to amplify the first transmit signals and a gain is variable when it is to amplify the second transmit signals, and wherein the gain of the first power amplifier and the gain of the preamplifier are controlled with a transmit power setting signal for setting amplitudes of transmit signals supplied by the first and second power amplifiers.

2. The transmitter circuit according to claim 1, wherein, when the supply of the first transmit signals from the first power amplifier is to be suspended, both the first power amplifier and the preamplifier are placed in a cut-off state.

3. The transmitter circuit according to claim 1, wherein the first power amplifier is configured of a Class C nonlinear high output amplifier and the second power amplifier is configured of a Class A linear amplifier.

4. The transmitter circuit according to claim 1, further provided with a transmit power detector for detecting the amplitude of the transmit signals supplied from the first power amplifier and a gain controller for controlling the gain of the first power amplifier with a signal detected by the transmit power detector and the transmit power setting signal.

5. The transmitter circuit according to claim 1, wherein the first transmit signals are of the AMPS system or the GSM system and the second transmit signals are of the CDMA system.
